(19) United States
(12) Patent Application Publication
(10) Pub. No.: US 2008/0228777 A1
(43) Pub. Date: Sep. 18, 2008

(54) Capture And Transfer Of Rich Media Content

(76) Inventor: Ranjit Ramesh Sawant, Fremont, CA (US)

Correspondence Address: Ashok Tankha, 36, Greenleigh Drive, Sewell, NJ, 08080, US

(21) Appl. No.: 12/047,323

(22) Filed: Mar. 13, 2008

Related U.S. Application Data
(60) Provisional application No. 60/906,932, filed on Mar. 14, 2007.

(51) Int. Cl. G06F 17/30

(52) U.S. Cl. 707/10; 707/E17.032

(57) ABSTRACT

Disclosed herein is a method and system for transferring rich media content from a mobile device to one or more publishing websites via a network. A client application is provided on a user's mobile device. The client application downloads media control widgets on the mobile device from a host website. The media control widgets comprise markup elements predefined in a markup language format and dynamic user interface components. The client application processes the markup elements and provides dynamic user interface components based on the markup elements. On initiating capture of rich media content by the user through the dynamic user interface components, the client application activates input devices of the mobile device and captures the rich media content. The client application transfers the captured rich media content to a publishing server via the network. The publishing server processes, stores, and publishes the rich media content on the publishing websites.

### CROSS REFERENCE TO RELATED APPLICATIONS

This application claims the benefit of provisional patent application number U.S. “60/906,932” titled “Systems And Method For Building Dynamic Applications On Mobile Devices Using A Markup Language Optimized For Rich User Inputs Such As Voice, Video, And Geographic Locations”, filed on “Mar. 14, 2007” in the United States Patent and Trademark Office.

### BACKGROUND

This invention in general relates to wireless technology. More particularly, this invention relates to rich media content transfer from a mobile device to a destination via a network.

Typical markup languages for portable devices render media content to a mobile device with access to the internet. A user of the mobile device can enter only text content as an input with these markup languages and post the text content on the network or the web. The existing markup languages place inherent limitations in capturing and storing rich media content inputs such as audio inputs, picture inputs, video inputs, and location inputs from input devices on the mobile phone such as a microphone, a video camera, or a global positioning system receiver. Further, there may be difficulties in transferring rich multimedia content captured on the mobile device to a particular website on the internet using the existing markup languages. Therefore there is a need for a computer markup language that allows users to record rich media inputs from the mobile device and transfer the recorded rich media inputs to the particular website on the internet.

Generally, a user follows an elaborate procedure comprising multiple procedural steps to transfer the rich media content captured on the mobile device to the particular website on the internet. After performing the initial procedural steps, the user may find the elaborate procedure inconvenient to follow on the mobile device and hence abandon the remaining procedural steps. The user may then limit the use of internet access for basic operations such as sending emails and browsing the internet. For example, if the user has to transfer the media content on the mobile device to the internet, the user first has to capture the media content, save the media content in a file, and then upload the file onto the website by accessing the internet via a browser application installed on the mobile device. Therefore, the user has to perform multiple operations to capture, store, and upload rich media information on the web.

The user may also need to use multiple mobile applications to perform each one of the multiple procedural operations. For example, if the user needs to take a picture, the user first needs to access a camera application to take the picture and then store the picture taken by the camera application in a file. The user then needs to open a browser application to upload the file on the web. The process of taking the picture and uploading the picture on the web may be easy on a personal computer with a dedicated keyboard and a pointing device but may be problematic on the mobile device with downsized keyboards and display screens and in the absence of the pointing device. Therefore, the user may underutilize interactive services available on the internet through the user's mobile device.

Mobile application providers may have to develop specialized applications on multiple device operating systems to capture rich media inputs on the mobile device because existing mobile applications such as the mobile browser may not allow capture of the rich media content. Due to the effort involved in porting the specialized applications on multiple mobile devices and the multiple device operating systems, the specialized applications may not be available on some of the mobile devices for use. Therefore, there is a need for dynamic mobile applications based on a computer markup language that allows the user to capture rich media inputs on the mobile device and allows the mobile application providers to develop new dynamic mobile applications based on the markup language in a convenient manner.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The method and system disclosed herein addresses the above stated needs for capturing rich media content on a mobile device of a user and transferring the rich media content to one or more publishing websites via a network by providing the user with media control widgets based on a markup language format on the mobile device. The media control widgets are dynamically created mobile applications comprising markup elements predefined in the markup language format and dynamic user interface components. The media control widgets enable the user to capture, store, and transfer the rich media content.

The method and system disclosed herein provides a client application on the mobile device of the user. The client application may download the media control widgets on the mobile device from one or more host websites. The client application then stores the downloaded media control widgets on the mobile device. The client application processes the markup elements of the media control widgets. The client application then dynamically provides the dynamic user interface components based on the markup elements of the media control widgets. The markup elements of the media control widgets enable the user to activate the input devices and capture the rich media content from input devices on the mobile device by using the dynamic user interface components on the client application. When the user initiates capture of the rich media content through the dynamic user interface components, the client application activates input devices on the mobile device and captures the rich media content through the input devices.

The client application may also store the captured rich media content on the mobile device. The user may preview the stored rich media content on the mobile device and group the stored rich media content on the mobile device. The user may also tag the captured rich media content on the mobile device prior to the storing of the captured rich media content.

The client application places the captured rich media content and rich media content information in the markup elements of the markup language format. The rich media content information comprises type of the rich media content, information on destination of transfer of the rich media content, time of transfer of the rich media content, and rich media content storing requirements. The client application then transfers the captured rich media content in the markup language format as marked up rich media content to a publishing server of one or more publishing websites via the network. The marked up rich media content comprises the markup elements, the rich media content, and the rich media content information.

The publishing server processes the marked up rich media content to obtain the rich media content and the rich media content information. The publishing server may then store the rich media content and the rich media content information. The publishing server then publishes the rich media content on one or more publishing websites. Each of the publishing websites may also be hosted on their respective publishing servers. The publishing server may also distribute the stored rich media content to other mobile devices. Multiple users may access the published rich media content on the publishing websites through an electronic device such as a mobile device, a laptop, or a computer.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a method of transferring rich media content from a mobile device to one or more publishing websites via a network.

FIG. 2 illustrates a system for transferring rich media content from a mobile device to one or more publishing websites via a network.

FIGS. 3A-3D exemplarily illustrate a flow chart describing a process of transferring rich media content from a mobile device to one or more publishing websites via a network.

FIG. 4 exemplarily illustrates a media control widget for recording video content through a client application on a mobile device.

FIG. 5 exemplarily illustrates a media control widget for controlling capture of video content through a client application on a mobile device.

FIG. 6 exemplarily illustrates a media control widget for obtaining context aware information based on location tracking capabilities of a mobile device.

### DETAILED DESCRIPTION OF THE INVENTION

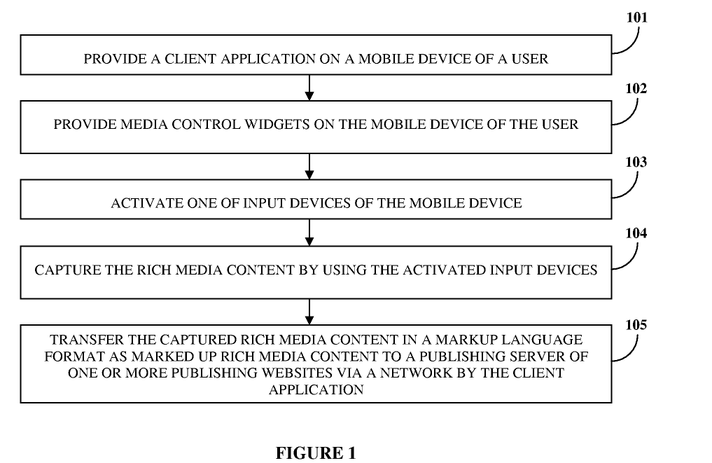

FIG. 1 illustrates a method of transferring rich media content from a mobile device 202 to one or more publishing websites via a network 203. The network 203 may be one of an internet and an intranet network. The rich media content may comprise multimedia content and location information of the mobile device 202. The location information of the mobile device 202 is determined based on location tracking capabilities such as global positioning system (GPS) capabilities of the mobile device 202. The multimedia content may comprise text content, visual images, audio content, and video content.

The method and system disclosed herein provides 101 a client application 202a on the mobile device 202 of the user 201. The client application 202a may be a web browser or a standalone software application installed on the mobile device 202 for transferring the rich media content from the mobile device 202 to one or more publishing websites hosted on a publishing server 204 via the network 203. The method and system disclosed herein provides 102 media control widgets on the mobile device 202 of the user 201. The client application 202a downloads media control widgets from one or more host websites on the mobile device 202. The media control widgets are dynamically created mobile applications comprising markup elements predefined in the markup language format and dynamic user interface components. The media control widgets enable the user 201 to capture, store, and transfer the rich media content.

The client application 202a stores the media control widgets on the mobile device 202. The media control widgets enable the user 201 to activate and capture rich media content from input devices on the mobile device 202 through the client application 202a. The client application 202a processes the markup elements of the media control widgets and then dynamically provides the dynamic user interface components of the media control widgets based on the processed markup elements. The dynamic user interface components of the media control widgets may enable the user 201 to provide text inputs, capture images, record a video, record an audio, or record geographic location of the user 201 on the mobile device 202 of the user 201 through the client application 202a. The dynamic user interface components may be menu items, clickable buttons, radio buttons, check boxes or any other user interface elements. For example, the client application 202a may download a media control widget for video content from a host website to enable the user 201 to record a video. The media control widget for the video content may comprise the markup elements in a markup language format as given below:

```
<Input type=″Video″ name=″vid_inputVaayooRecordedVideo″
ipid=″123″ Required=″false″>video binary goes here
for upload</Input>
<CommandButton tiedtoInput=″123″> AutoRecord=”false”
Autorecordinterval=”0”>
    <Handler>RecordVideo</Handler>
    Record the Video Memo
</CommandButton>
<Label>Tag Video</Label>
<Input type=″Text″ name=″MemoDescribe″ ipid=″124″
Required=″false″>Enter Memo Description here</Input>
<TextBox tiedtoInput=″124″/>
<Label>Save or Retrieve to the web</Label>
<Input type=″Text″ name=″Memoretriev″ ipid=″125″
Required=″false″>Enter the memos to retrieve</Input>
<TextBox tiedtoInput=″125″/>
<ProviderWebService Async=″1″
URL=″http://www.vaayoo.com/VideoMemoService.asmx″/>
      <CommandButton><Handler>WebServiceCall</Handler>Submit
for Save or Retrieve</CommandButton>
```

The “<Input>” tag may represent a tag for storing the rich media content. The value of the “<Input>” tag is a place holder for binary data of the captured rich media content. The “type” attribute for the “<Input>” tag may denote the type of the rich media content to be stored. The type of the rich media content may be a digital image content, audio content, video content, or location of the mobile device 202. The “Required” attribute may specify if the recording and storing of the rich media content is optional or a requirement. The “<CommandButton>” Button may denote dynamic user interface component to be displayed to activate the input devices on the mobile device 202. The text on “<CommandButton>” markup element may be shown on the dynamic user interface component. The “tiedtolnput” may point to the <Input> tag which is a place holder for the rich media content.

If the value of the “AutoRecord” markup element is set to “true” then the input devices may be automatically activated without intervention of the user 201 when the dynamic user interface component of the media control widget for video content is displayed. The “AutoRecord” markup element set to “true” may be used in GPS based applications which require a continuous recording of GPS coordinates of the mobile device 202 to determine the location of a moving mobile device 202. The “AutoRecordInterval” may set time interval for automatically recording the rich media content. The “<Handler>” tag may denote type of the input devices to be activated. For example, the “<Handler>” tag accompanied by a “RecordAudio” may activate an audio recorder on the mobile device 202, a “RecordVideo” may activate a camera for recording a video on the mobile device 202, a “RecordPicture” may activate a camera for capturing a picture on the mobile device 202, a “RecordLocation” may activate GPS on the mobile device 202, and a “RecordText” may activate a text editor on the mobile device 202. The “<ProviderWebService>” tag specifies destination information of the publishing server 204 where the markup elements containing the rich media content are to be transferred. The “Async” attribute specifies if the transfer of the rich media content happens instantaneously or at a later time. The “URL” attribute specifies endpoint location on the publishing server 204 where the markup elements containing the rich media content are to be transferred.

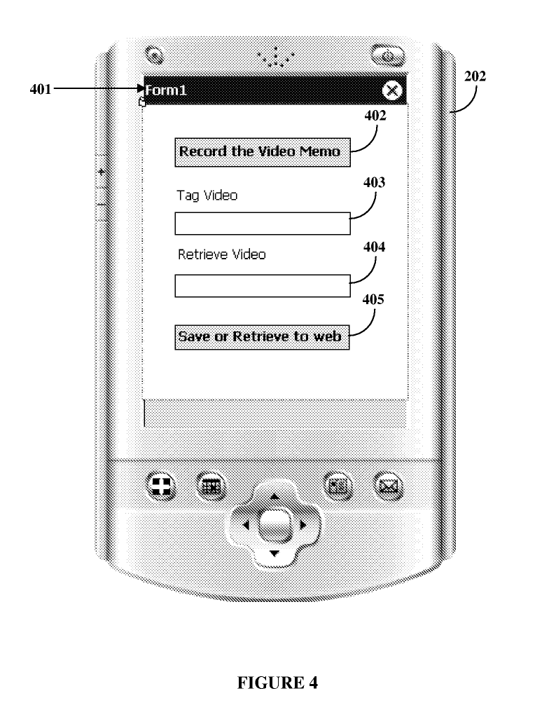

On processing the markup elements of the media control widget for video content, the client application 202a dynamically provides a dynamic user interface component based on the processed markup elements. For example, the client application 202a may process the markup elements of the media control widget for video content and provide a “Record the Video Memo” button 402, a “Tag Video” text box 403, a “Retrieve Video” text box 404, and a “Save or Retrieve to web” button 405 on “Form1” 401 as illustrated in FIG. 4.

When the user 201 initiates capture of the rich media content through the dynamic user interface components, the client application 202a activates 103 one of the input devices on the mobile device 202 and captures the rich media content through the input devices. The input devices may comprise image capturing devices, video capturing devices, audio capturing devices, and location capturing devices such as global positioning system receivers. The user 201 utilizes dynamic user interface components of the media control widgets on the client application 202a to activate the input devices. For example, the user 201 may click on “Record the Video Memo” button 402 to activate a camera on the mobile device 202 for recording a video. The activation of the input devices may also performed automatically by the media control widgets.

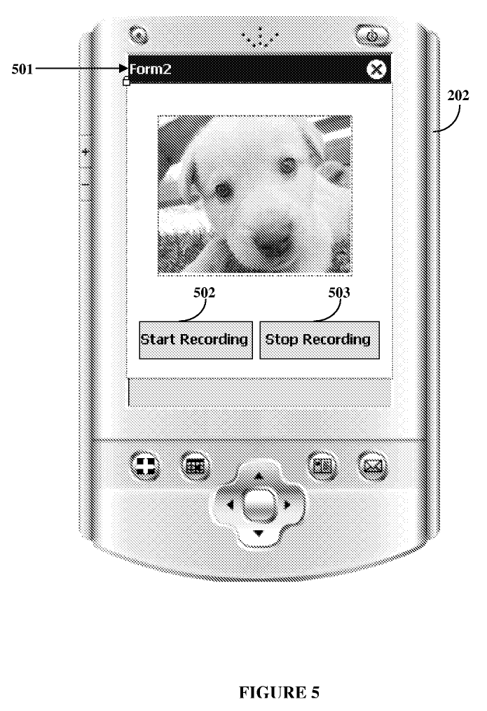

The input devices capture 104 rich media content on the mobile device 202. The user 201 uses the dynamic user interface components to control the capture of the rich media content on the client application 202a as illustrated in FIG. 5. The user 201 may control the initiation and termination of the capture of the rich media content using the dynamic user interface components. For example, the user 201 may click on “Start Recording” button 502 on “Form2” 501 on the client application 202a to initiate recording video content on the mobile device 202 and then click on “Stop Recording” button 503 to terminate the recording of the video content on the mobile device 202 as illustrated in FIG. 5. The capture of the rich media content may also be performed automatically by the media control widgets. The automatic capture of the rich media content may be used in global positioning system (GPS) based applications of the mobile device 202 to determine the location of a moving mobile device 202 at appropriate intervals of time. The initiation and termination of the capture of the rich media content may also be performed automatically by the media control widgets by predefining a time interval for the capturing of the rich media content on the mobile device 202.

The user 201 may capture multiple rich media content by activating a particular input device for particular rich media content through the client application 202a consecutively. For example, the user 201 may first record a video by activating a camera on the mobile device 202 for recording the video. The user 201 may then capture a picture by activating a camera on the mobile device 202 for capturing pictures. The user 201 may then capture an audio by activating an audio recording device on the mobile device 202.

The client application 202a may then store the captured rich media content on the mobile device 202. The client application 202a may store the captured rich media content in mobile device memory or in a memory disk provided on the mobile device 202. The captured rich media content may be stored at an instant when the particular rich media content is captured on the mobile device 202. The user 201 may preview the stored rich media content on the mobile device 202 and group the stored rich media content on the mobile device 202. The user 201 may also tag the captured rich media content on the mobile device 202 prior to the storing of the rich media content on the mobile device 202 and transferring of the rich media content to the publishing websites. For example, a “preview” markup element may be provided for a media control widget for video content for viewing recorded video on the mobile device 202. The user 201 may also provide a tag name in the “Tag Video” text box 403 to identify the recorded video after recording the video and prior to storing the recorded video on the mobile device 202 as illustrated in FIG. 4.

The client application 202a places the captured rich media content in the markup elements of the markup language format. Exemplarily, the captured rich media content such as video content may be placed in the markup elements as given below:

<Input type=″Video″ name=″vid_inputVaayooRecordedVideo″ ipid=″123″
Required=″false″>
IyFBTVIKDJtCuuJxNN8in0iKKIAMUoEH/9t3/tufHyEGpgwaAOr//6fvCnf/NvY8DGk
Ax/d+/7F9LBdqxyAMSVcv//v/8K9/uyjiTAxJGE//+vf3h2c6A5FQDKoUh//
+iNJ8fHx8fHx8RCqpvojSfHx8fHx8fEQqvUsI0nx8fHx8fHxEMkPOiNJ8fHx8fHx8RDL
dSwjSfHx8fHx8fEQqqb6I0nx8fHx8fHxEKr1DaNJ8fHx8fA==..............................
..............
</Input>

The client application 202a further places rich media content information in the markup elements of the markup language format. The rich media content information comprises type of the rich media content, information on destination of transfer of the rich media content, time of transfer of the rich media content, and rich media content storing requirements. For example, the destination information of the publishing server 204 is stored in the “<ProviderWebService>” tag of the markup language format as given below:

<ProviderWebService Async=″1″
URL=″http://www.vaayoo.com/VideoMemoService.asmx″/>
<CommandButton><Handler>WebServiceCall</Handler>Submit for
Save or Retrieve</CommandButton>

For example, the client application 202a may initiate the transfer of the captured rich media content when the user 201 clicks on the button associated with the “<Handler>” tag with markup element value of the “<Handler>” tag set to “WebServiceHandler”. Alternatively, the transfer of the rich media content may be initiated automatically by the client application 202a. The client application 202a then transfers 105 the captured rich media content in the markup language format as marked up rich media content to a publishing server 204 of one or more publishing websites via the network 203. The marked up rich media content comprises the markup elements, the rich media content, and the rich media content information.

The publishing server 204 may be provided for each of the publishing websites. The publishing server 204 receives the marked up rich media content at the endpoint location mentioned in the markup language format. The publishing server 204 processes the marked up rich media content to obtain the rich media content and the rich media content information. The publishing server 204 stores the rich media content and the rich media content information. Further, the publishing server 204 publishes the rich media content on the publishing websites. The rich media content may be accessed by multiple users. The multiple users may access the rich media content by accessing the published websites using electronic devices such computers, laptops or mobile devices of the multiple users.

If the user 201 had tagged the rich media content on the mobile device 202, the tagged rich media content may be used for identification, search, and retrieval of the rich media content on the publishing websites by the user 201 at a subsequent period of time after the transfer of the rich media content. For example, the user 201 may provide the tag name given to a rich media content previously stored and transferred to the published websites on the “Retrieve Video” text box 404. The user 201 may then click on the “Save or Retrieve to web” button 405 on the client application 202a as illustrated in FIG. 4 to save the rich media content on the mobile device 202 or to access the rich media content at a subsequent period of time after the transfer of the rich media content from the mobile device 202. Therefore, the media control widgets comprising the markup elements predefined in the markup language format enable the user 201 to transfer and access the rich media content to one or more publishing websites via the network 203.

Consider an example of the method disclosed herein. A user 201 may wish to search for a particular restaurant in vicinity of the user 201. The user 201 may download a media control widget comprising markup elements for recording the user's 201 geographic location, inputting text for type of cuisine the user 201 wants to search in the user's 201 vicinity, and providing the endpoint location on the publishing server 204 which provides the business services that allow the user 201 to search for restaurants in proximity to the user's 201 geographic location. The media control widget for recording the geographic location of the user 201, inputting text for type of cuisine, and providing the endpoint location may comprise the markup elements in a markup language format as given below:

```
<Input type=″Location″ name=″loc_inputRecordedGPS″ ipid=″456″
Required=″false″>location coordinates go here</Input>
<CommandButton tiedtoInput=″456″>
    <Handler>RecordLocation</Handler>
    Record the Current Location
</CommandButton>
<Label>Enter Cuisine</Label>
<Input type=″Text″ name=″txt_CuisineSearch″ ipid=″457″
Required=″true″>Cuisine place holder</Input>
<TextBox tiedtoInput=″457″/>
<ProviderWebService Async=″0″
URL=
″http://www.restaurantsearch2222.com/FindResturantService.asmx″/>
      <CommandButton><Handler>WebServiceCall</Handler>Search
Restaurants</CommandButton>
```

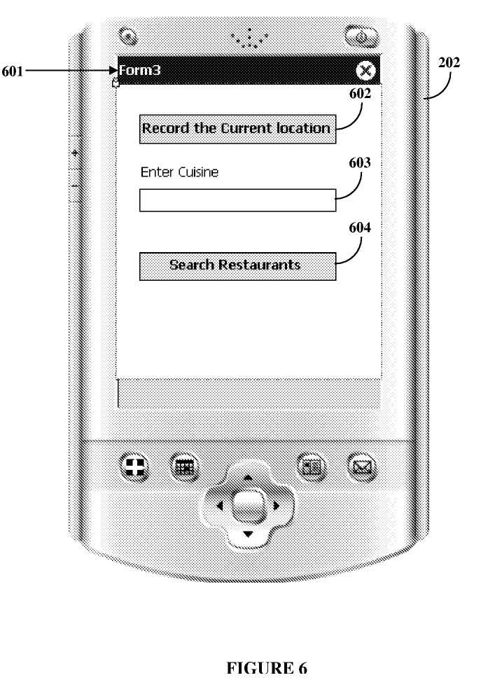

The client application 202a processes the markup elements for recording the user's 201 geographic location and displays a “Form3” 601 window on the client application 202a. The “Form3” 601 window provides a “Record the Current Location” button 602 to capture the location of the mobile device 202, a “Enter Cuisine” text box 603 to enter the type of cuisine and a “Search Restaurants” button 604 to transfer the location and cuisine information to the publishing server 204 as illustrated in FIG. 6. The user 201 may then click the “Record the Current location” button 602 and enter the type of cuisine in the “Enter Cuisine” text box 603. User input and GPS derived location coordinates are captured and stored in respective input fields. The user 201 then clicks the “Search Restaurants” button 604 to submit the captured input data to the publishing server 204. The publishing server 204 processes the location information and the type of cuisine requested by the user 201. The publishing server 204 then returns a list of suitable restaurants and associated details to the mobile device 202 of the user 201. The attribute “Async” set to 0 denotes that the search operation happens immediately or synchronously after the user 201 clicks the “Search Restaurants” button 604.

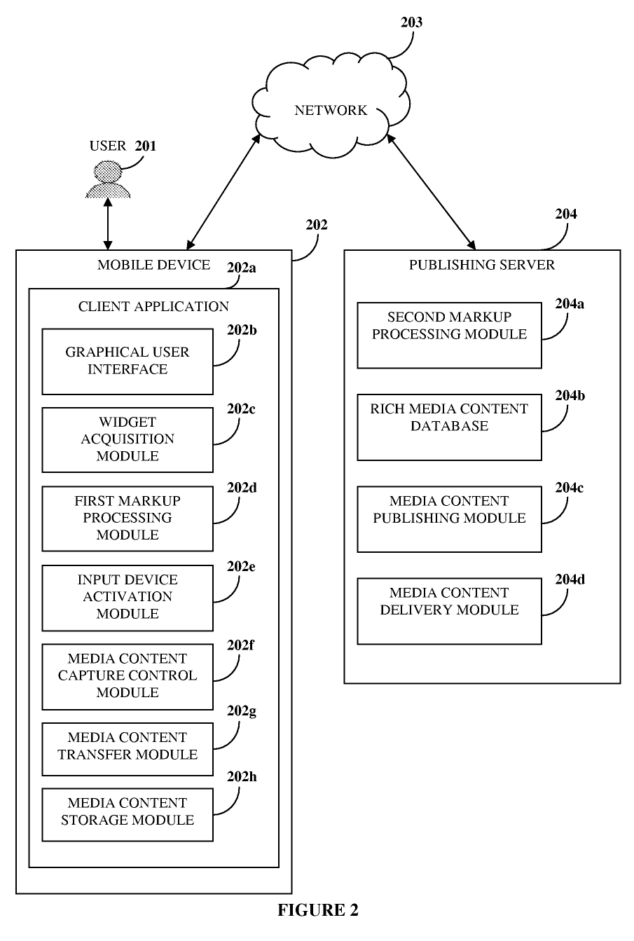

FIG. 2 illustrates a system for transferring rich media content from a mobile device 202 to one or more publishing websites via a network 203. The system disclosed herein comprises a client application 202a on the mobile device 202 of the user 201 and a publishing server 204 connected via the network 203. The network 203 may be an internet or an intranet network. The client application 202a comprises a graphical user interface (GUI) 202b, a widget acquisition module 202c, a first markup processing module 202d, an input device activation module 202e, a media content capture control module 202f, a media content transfer module 202g, and a media content storage module 202h.

The widget acquisition module 202c of the client application 202a acquires media control widgets on the mobile device 202 from one or more host websites. The media control widgets comprise markup elements predefined in a markup language format and dynamic user interface components. The media control widgets may be acquired based on actions the user 201 needs to perform, type of rich media content to be captured, or type of input devices to be activated on the mobile device 202. For example, a media control widget for video content may be acquired when the user 201 needs to record a video by activating a camera on the mobile device 202 and then transferring the recorded video to the publishing server 204.

The media control widgets may also be acquired based on the business services the user 201 uses on the mobile device 202. For example, the user's 201 subscription to a video memo recorder service may initiate the acquisition of a video memo recorder media control widget with predefined markup elements and display the dynamic user interface components that enable the user 201 to capture a video, preview the captured video, tag the captured video, transfer the captured video to the publishing server 204, or retrieve the video from the publishing server 204. Alternatively, the media control widgets may be acquired automatically by the client application 202a without any user action. The first markup processing module 202d processes the markup elements of the media control widgets. The client application 202a then dynamically provides the dynamic user interface components of the media control widgets based on the processed markup elements on the GUI 202b.

When the user 201 initiates capture of the rich media content through the dynamic user interface components displayed on the GUI 202b, the input device activation module 202e activates one of the input devices of the mobile device 202 for capturing rich media content on the mobile device 202. The media content capture control module 202f controls the capture of the rich media content by the activated input devices. The media content capture control module 202f may control the initiation and termination of the capture of the rich media content on the mobile device 202. The media content storage module 202h stores the captured rich media content in the markup language format and the media control widgets on the mobile device 202.

The media content transfer module 202g then transfers the captured rich media content in the markup language format as marked up rich media content to the publishing server 204 on one or more publishing websites via the network 203. The marked up rich media content comprises the markup elements, the rich media content, and the rich media content information. The rich media content information comprises type of the rich media content, information on destination of transfer of the rich media content, time of transfer of the rich media content, and rich media content storing requirements. The publishing server 204 may be provided on each of the publishing websites. The publishing server 204 comprises a second markup processing module 204a, a rich media content database 204b, a media content publishing module 204c, and a media content delivery module 204d.

The second markup processing module 204a of the publishing server 204 processes the marked up rich media content to obtain the rich media content and the rich media content information. The publishing server 204 then stores the rich media content and the rich media content information in the rich media content database 204b. The media content publishing module 204c then publishes the rich media content in the rich media content database 204b on one or more publishing websites. Multiple users may then access the published rich media content on the publishing website through an electronic device such as a mobile device 202, a laptop or a computer.

The media content delivery module 204d delivers the rich media content to the mobile device 202 of the user 201. The media content delivery module 204d may deliver the rich media content based on a user request made on the publishing websites or a request from the mobile device 202 of the user 201 through the client application 202a. The request from the mobile device 202 may be for retrieving the rich media content from the published websites or obtaining context aware information based on location of the mobile device 202. The second markup processing module 204a may process the marked up rich media content associated with the requests. For example, the second markup processing module 204a may process the marked up rich media content containing the geographical location of the user 201 by the client application 202a and determine the GPS coordinates of the mobile device 202. The media content delivery module 204d may then provide context aware information such as business services in proximity to geographical location of the user 201, advertisements of the business services, coupons of the business services, schedule of events at the user's 201 geographical location, weather forecasts, and traffic updates based on the determined GPS coordinates of the mobile device 202.

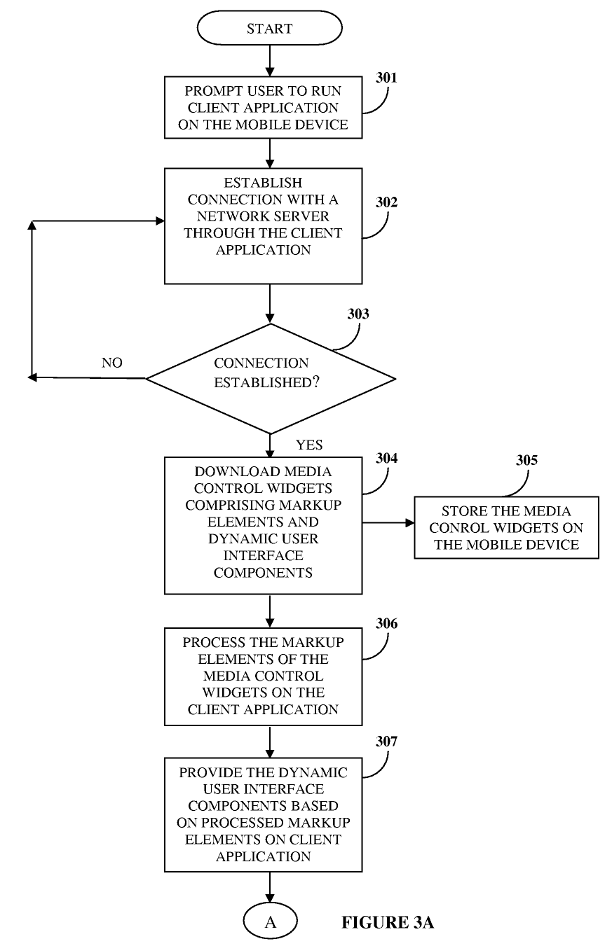

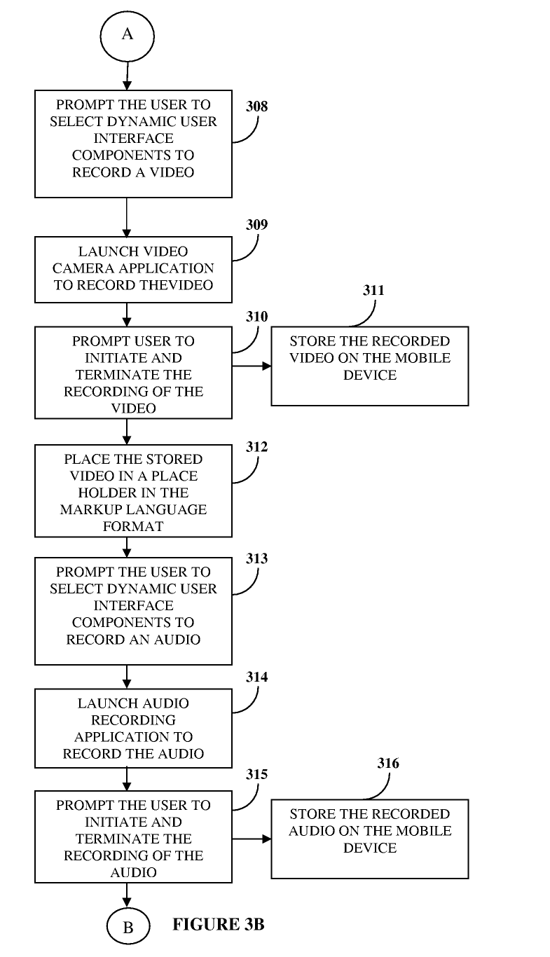

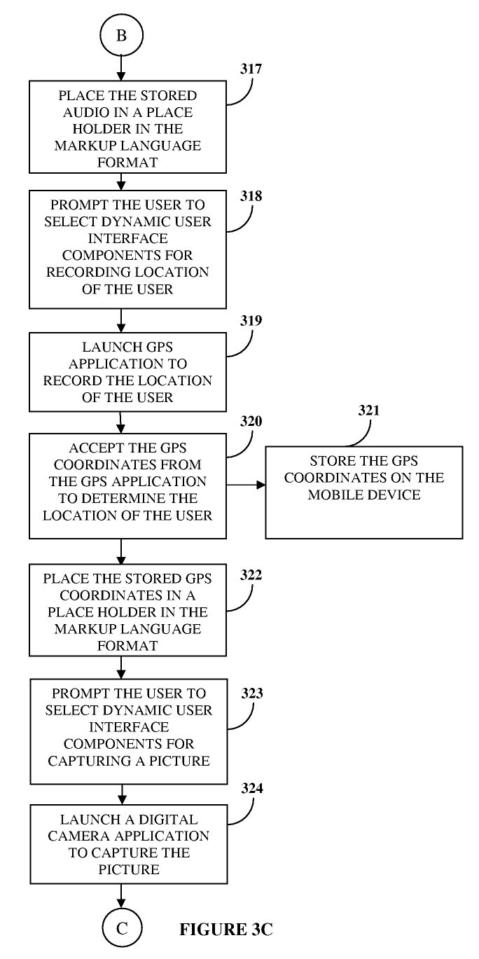

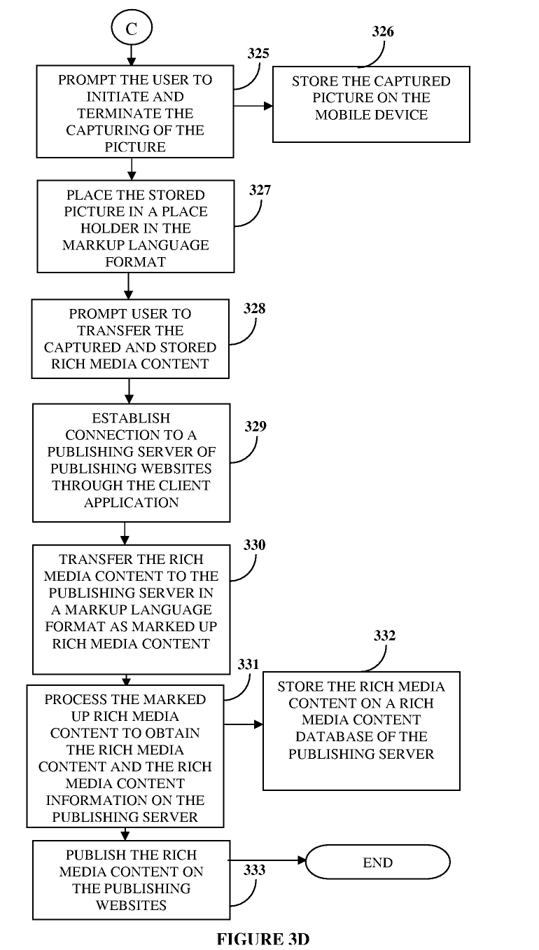

FIGS. 3A-3D exemplarily illustrate a flow chart describing a process of transferring rich media content from a mobile device 202 to one or more publishing websites via a network 203. The user 201 runs 301 the client application 202a on the mobile device 202. The client application 202a establishes 302 a connection with a network server of the host website. If the connection to the network server is established 303, then the client application 202a downloads 304 the media control widgets comprising markup elements in a markup language format and dynamic user interface components from the network server for activating and capturing rich media content. For example, the client application 202a may download an extensible markup language (XML) schema with the markup elements for rich media content inputs. The downloaded media control widgets may be used for recording a video, capturing a still picture, recording an audio message or recording the user's 201 geographical location. The client application 202a stores 305 the downloaded media control widgets on the mobile device 202 of the user 201.

The client application 202a then processes 306 the markup elements of the media control widgets. For example, the client application 202a may process the “<Input>” tag, the “type” attribute, the “<CommandButton>” markup element, the “<Handler>” tag and other markup elements of the XML schema. The client application 202a then dynamically provides 307 the dynamic user interface components such as forms, clickable buttons, widget windows, text boxes, menu items etc. of the media control widgets on the client application 202a based on the processed markup elements. For example, the client application 202a may provide a form or a web page with dynamic user interface components on the form to capture the rich media content. The user 201 first selects 308 the dynamic user interface components of a media control widget for recording a video. The client application 202a launches 309 the video camera application for recording the video. The user 201 initiates and terminates 310 the recording of the video from the video camera application using the dynamic user interface components on the client application 202a. The client application 202a then stores 311 the recorded video on the mobile device 202. The video may be placed 312 in a placeholder in the markup language format. For example, the client application 202a may place the stored video content in the placeholder by adding the stored video content in the “<Input>” tag.

The user 201 may then select 313 the dynamic user interface components of a media control widget for recording an audio. The client application 202a launches 314 the audio recording application for recording the audio. The user 201 initiates and terminates 315 the recording of the audio from the audio recording application using the dynamic user interface components on the client application 202a. The client application 202a then stores 316 the recorded audio on the mobile device 202. The stored audio may be placed 317 in a placeholder in the markup language format. For example, the client application 202a may place the stored audio content in the placeholder by adding the stored audio content in the “<Input>” tag.

The user 201 may then select 318 the dynamic user interface components of a media control widget for recording location of the user 201 of the mobile device 202. The client application 202a launches 319 the GPS application on the mobile device 202 for recording the location of the user 201. The client application 202a accepts 320 GPS coordinates of the mobile device 202 from the GPS application to determine the location of the user 201 of the mobile device 202. The client application 202a then stores 321 the GPS coordinates on the mobile device 202. The stored GPS coordinates may be placed 322 in a placeholder in the markup language format. For example, the client application 202a may place the stored GPS coordinates on the mobile device 202 in the placeholder by adding the stored GPS coordinates in the “<Input>” tag.

The user 201 may then select 323 the dynamic user interface components of a media control widget for capturing a picture. The client application 202a launches 324 the digital camera application for capturing the picture. The user 201 initiates and terminates 325 the capturing of the picture from the digital camera application using the dynamic user interface components on the client application 202a. The client application 202a then stores 326 the captured picture on the mobile device 202. The stored picture may be placed 327 in a placeholder in the markup language format. For example, the client application 202a may place the stored picture in the placeholder by adding the stored picture in the “<Input>” tag.

The user 201 then selects the dynamic user interface components on the client application 202a for transferring 328 the stored video, the stored audio, the stored GPS coordinates, and the stored picture. The client application 202a then establishes 329 a connection with the publishing server 204 hosting one or more publishing websites. The client application 202a transfers 330 the stored video, the stored audio, the stored GPS coordinates, and the stored picture in a markup language format as marked up rich media content to the publishing server 204 of one or more publishing websites. The marked up rich media comprises the markup elements, the rich media content, and the rich media content information. For example, the client application 202a may transfer the rich media content along with the “<Input>” tag for each of the stored video, the stored audio, the stored GPS coordinates, and the stored picture to the publishing server 204. The publishing server 204 of a publishing website processes 331 the marked up rich media content to obtain the rich media content and the rich media content information. For example, the publishing server 204 may interpret the “<Input>” tag of each of the rich media content in the marked up rich media content and obtain the rich media content. The publishing server 204 then stores 332 the rich media content and the rich media content information in the rich media content database 204b. The publishing server 204 may convert the stored rich media content to a standard format predefined for publishing the rich media content on one or more publishing websites. The publishing server 204 then publishes 333 the rich media content on one or more publishing websites. Multiple users may then access the published rich media content on the publishing website hosted on the publishing server 204 through an electronic device such as a mobile device 202, a laptop, or a computer.

It will be readily apparent that the various methods and algorithms described herein may be implemented in a computer readable medium appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A ‘processor’ means any one or more microprocessors, Central Processing Unit (CPU) devices, computing devices, microcontrollers, digital signal processors or like devices. The term ‘computer-readable medium’ refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product comprising computer executable instructions embodied in a computer-readable medium comprises computer parsable codes for the implementation of the processes of various embodiments.

Where databases are described such as the rich media content database 204b, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, UltraSPARC® processors, etc. that are adapted to communicate with the computer. Any number and type of machines may be in communication with the computer.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A method of transferring rich media content from a mobile device to one or more of a plurality of publishing websites via a network, comprising the steps of:
providing a client application on said mobile device of a user;
providing a plurality of media control widgets on the mobile device of said user, wherein said media control widgets comprise a plurality of markup elements predefined in a markup language format;
activating one of a plurality of input devices of the mobile device by processing said markup elements by said client application;
capturing said rich media content by using said activated input devices; and
transferring said captured rich media content in said markup language format as marked up rich media content to a publishing server of one or more of said publishing websites via said network by the client application, wherein the network is one of an internet and an intranet network;
whereby the media control widgets comprising the markup elements predefined in the markup language format enable the user to capture and transfer the rich media content to one or more of the publishing websites via the network.

2. The method of claim 1, wherein the client application is one of a web browser and a standalone software application used for transferring the rich media content from the mobile device to one or more of the publishing websites via the network.

3. The method of claim 1, wherein the client application downloads the media control widgets from one or more of a plurality of host websites via the network and stores the media control widgets on the mobile device.

4. The method of claim 1, wherein the media control widgets further comprise dynamic user interface components, wherein said dynamic user interface components enable the user to perform said steps of activating one of said input devices, capturing the rich media content, and transferring the rich media content to one or more of the publishing websites via the network.

5. The method of claim 4, wherein the client application dynamically provides the dynamic user interface components based on the markup elements of the media control widgets.

6. The method of claim 4, wherein said transferred rich media content is accessed by a plurality of users, wherein said users may access the transferred rich media content by one of retrieving the transferred rich media content using the dynamic interface components on the client application and accessing the transferred rich media content on the publishing websites.

7. The method of claim 6, wherein the rich media content is tagged on the client application for identification, search, and said retrieval of the transferred rich media content from the publishing websites by the users.

8. The method of claim 1, wherein said marked up rich media content comprises the markup elements, the rich media content, and rich media content information, wherein said rich media content information comprises type of the rich media content, information on destination of transfer of the rich media content, time of transfer of the rich media content, and rich media content storing requirements.

9. The method of claim 8, further comprising a step of processing the marked up rich media content at the publishing server to obtain the rich media content and the rich media content information.

10. The method of claim 1, wherein the rich media content comprises one of multimedia content and location information of the mobile device, wherein said multimedia content comprises one of text content, visual images, audio content, and video content.

11. The method of claim 10, wherein said location information of the mobile device is determined based on location tracking capabilities of the mobile device, further wherein the location information of the mobile device is used to provide context aware information to the user of the mobile device.

12. The method of claim 11, wherein said context aware information comprises one of information on business services in proximity to geographical location of the user, advertisements of said business services, coupons of the business services, schedule of events at said geographical location of the user, weather forecasts, and traffic updates.

13. The method of claim 1, wherein said input devices comprise one or more of image capturing devices, video capturing devices, audio capturing devices, and location capturing devices.

14. A system for transferring rich media content from a mobile device to one or more of a plurality of publishing websites via a network, comprising:
a client application on said mobile device of a user, comprising:
a widget acquisition module for acquiring media control widgets on the mobile device from one or more of a plurality of host websites, wherein
said media control widgets comprise a plurality of markup elements predefined in a markup language format;
a first markup processing module for processing said markup elements predefined in said markup language format;
an input device activation module for activating one of a plurality of input devices of the mobile device based on said processing of the markup elements;
a media content capture control module for controlling capture of said rich media content by said activated input devices; and
a media content transfer module for transferring of said captured rich media content in the markup language format as marked up rich media content to a publishing server of one or more of said publishing websites via said network, wherein the network is one of an internet and intranet network.

15. The system of claim 14, wherein the client application further comprises a graphical user interface for displaying dynamic user interface components of the media control widgets, wherein said dynamic user interface components are dynamically provided by the client application based on the processed markup elements.

16. The system of claim 14, wherein the client application further comprises a media content storage module for storing the captured rich media content in the markup language format and the media control widgets on the mobile device.

17. The system of claim 14, wherein the publishing server comprises a second markup processing module for processing said marked up rich media content, wherein the marked up rich media content comprises the markup elements, the rich media content, and rich media content information.

18. The system of claim 17, wherein the publishing server further comprises a rich media content database for storing the rich media content and said rich media content information, wherein the rich media content information comprises type of the rich media content, information on destination of transfer of the rich media content, time of transfer of the rich media content, and rich media content storing requirements.

19. The system of claim 18, wherein the publishing server further comprises a media content publishing module for publishing the rich media content on one or more of the publishing websites, wherein said published rich media content is accessed by a plurality of users on the publishing websites.

20. The system of claim 19, wherein the publishing server is provided for each of the publishing websites.

21. The system of claim 19, wherein the publishing server comprises a media content delivery module for delivering the rich media content to the mobile device of the user.

22. The system of claim 21, wherein said delivery of the rich media content is based on one of a user request made on a host website and a request from the client application.

23. A computer program product comprising computer executable instructions embodied in a computer-readable medium, wherein said computer program product comprises:
a first computer parsable program code for providing a client application on a mobile device of a user;
a second computer parsable program code for providing a plurality of media control widgets on said mobile device of said user, wherein said media control widgets comprise a plurality of markup elements predefined in a markup language format;
a third computer parsable program code for processing said markup elements by said client application;
a fourth computer parsable program code for activating one of a plurality of input devices of the mobile device based on said processing of the markup elements;
a fifth computer parsable program code for controlling capture of rich media content on the client application by using said activated input devices; and
a sixth computer parsable program code for transferring said captured rich media content in said markup language format as marked up rich media content to a publishing server of one or more of publishing websites via a network by the client application.
